(19) United States
(12) Patent Application Publication
(10) Pub. No.: US 2021/0107460 A1
(43) Pub. Date: Apr. 15, 2021

(54) VEHICLE PARKING ASSIST APPARATUS

(71) Applicant: TOYOTA JIDOSHA KABUSHIKI KAISHA, Toyota-shi (JP)

(72) Inventors: Yuki MINASE, Toyota-shi (JP); Takuya NAKAGAWA, Nagoya-shi (JP); Junji HORIGUCHI, Nagoya-shi (JP); Norio IMAI, Anjo-shi (JP)

(73) Assignee: TOYOTA JIDOSHA KABUSHIKI KAISHA, Toyota-shi (JP)

(21) Appl. No.: 16/989,379

(22) Filed: Aug. 10, 2020

(30) Foreign Application Priority Data
Oct. 11, 2019 (JP) 2019-187474

(51) Int. Cl. B60W 30/06; B60W 50/10; B60W 40/105

(52) U.S. Cl. CPC B60W 30/06; B60W 2050/0063; B60W 40/105; B60W 50/10

(57) ABSTRACT

Accuracy of acquired parking space information on a parking space having a target parking range set therein is increased when the parking space information is registered. A vehicle parking assist apparatus (10) has a registration mode for registering the information on the parking space having the target parking range set therein, and a plurality of vehicle speed modes having different travel speeds of a vehicle (100) during execution of parking travel processing. The plurality of vehicle speed modes include two or more vehicle speed modes, one of which is selectable by a user. When the registration mode is not selected, during the execution of the parking travel processing, the vehicle parking assist apparatus (10) causes the vehicle (100) to travel in the vehicle speed mode selected by the user. When the registration mode is selected, during the execution of the parking travel processing, the vehicle parking assist apparatus (10) causes the vehicle (100) to travel in a predetermined one vehicle speed mode of the plurality of vehicle speed modes regardless of the vehicle speed mode selected by the user.

### BACKGROUND OF THE INVENTION

### 1. Field of the Invention

The present invention relates to a vehicle parking assist apparatus.

### 2. Description of the Related Art

Hitherto, there has been known a vehicle parking assist apparatus configured to automatically park a vehicle in a parking space specified by a driver. When the vehicle is to be parked in the parking space, such a parking assist apparatus is configured to calculate a current position of the vehicle based on information such as image information, object information, the number of rotations of tire, a steering angle, a steering torque, a vehicle speed, a yaw rate, a longitudinal acceleration, and a lateral acceleration, and to automatically park the vehicle in the parking space while recognizing a positional relationship between the vehicle and the parking space.

Moreover, when the vehicle is to be parked in the specified parking space, the vehicle parking assist apparatus is configured to able to register information on the parking space (hereinafter referred to as “parking space information”). For example, there has been known a configuration in which a parking space and 3D objects existing in a vicinity of the parking space are taken by cameras, and characteristic points of the 3D objects in taken images (hereinafter sometimes referred to as “camera images”) are registered as the parking space information (for example, see Japanese Patent Application Laid-open No. 2017-138664). Moreover, for such a parking assist apparatus, there has been known a configuration in which a current position of the vehicle is calculated based on the camera images, and a relationship between the current position of the vehicle and a target parking space is calculated.

In such a vehicle parking assist apparatus, it is preferred to increase accuracy of extraction of the characteristic points and accuracy of the calculation of the current position of the vehicle in order to increase accuracy of the parking space information to be acquired. Moreover, for that purpose, it is preferred that the vehicle speed be low when the information to be used for the calculation is acquired. That is, when the vehicle speed increases, blur of the camera image to be taken increases, and there is a fear in that the accuracy of the extraction of the characteristic points may decrease. Moreover, when the vehicle speed increases, a slip is liable to occur in the vehicle, and there is a fear in that a separation between the current position of the vehicle to be calculated and the actual current position of the vehicle may be liable to occur. However, when the vehicle speed is suppressed to be low during the execution of the parking assist control, the vehicle cannot quickly be parked in the parking space even when the parking space information is not to be registered.

As speed control to be executed when the vehicle is caused to automatically travel, in Japanese Patent Application Laid-open No. 2007-118804, there is disclosed a configuration in which a plurality of target speeds are set stepwise, and the target speed can be changed in accordance with an accelerator operation and a brake operation by a driver. Moreover, in Japanese Patent Application Laid-open No. 2007-118804, there is disclosed that, with this configuration, the travel speed of the vehicle can be changed to any one of the plurality of set target speeds in accordance with a situation around the vehicle and the like, and as a result, driving operation assist that is smooth and excellent in operability can be achieved.

However, according to the configuration disclosed in Japanese Patent Application Laid-open No. 2007-118804, the vehicle speed set by the driver or the like is not always a vehicle speed at which the parking space information can be registered with high accuracy.

### SUMMARY OF THE INVENTION

The present invention has been made in view of the above-mentioned problem, and therefore has an object to provide a parking assist apparatus capable of increasing accuracy of parking space information to be registered.

According to at least one embodiment of the present invention, there is provided a vehicle parking assist apparatus, which is configured to execute parking travel processing of causing a vehicle (100) to travel so that the vehicle is accommodated within a target parking range set in a parking space, the vehicle parking assist apparatus having: a registration mode selectable by a user to register information on the parking space having the target parking range set therein; and a plurality of vehicle speed modes having different travel speeds of the vehicle (100) during the execution of the parking travel processing, wherein the plurality of vehicle speed modes include two or more vehicle speed modes, one of which is selectable by the user, wherein when the registration mode is not selected, during the execution of the parking travel processing, the vehicle parking assist apparatus controls a vehicle speed in accordance with one of the plurality of vehicle speed modes selected by the user or the like, and wherein when the registration mode is selected, during the execution of the parking travel processing, the vehicle parking assist apparatus controls a vehicle speed in accordance with a predetermined one vehicle speed mode of the plurality of vehicle speed modes regardless of the one of the plurality of vehicle speed modes selected by the user or the like.

According to at least one embodiment of the invention configured in such a manner, when the information to be used to acquire the parking space information on the parking space having the target parking range set therein (the parking space including the target parking range) is to be acquired, the vehicle speed is controlled in accordance with the predetermined one vehicle speed mode regardless of the vehicle speed mode set by a driver or the like, who is the user of the vehicle (100). Therefore, the vehicle can be caused to travel at the vehicle speed allowing accurate acquisition of the information to be used to acquire the parking space information. Thus, highly accurate parking space information can be acquired and registered.

The following configuration is applicable: the predetermined one vehicle speed mode is, of the plurality of vehicle speed modes, one of which is selectable by the user, a vehicle speed mode having a target speed of the vehicle (100) set to the lowest value.

The accuracy of the information acquired during the travel of the vehicle increases as the vehicle speed decreases. Therefore, the accuracy of the information required to acquire the parking space information can be increased by setting the vehicle speed mode in the registration mode to the vehicle speed mode having the target speed of the vehicle (100) set to the lowest value. Thus, highly accurate parking space information can be acquired and registered.

The following configuration is applicable: the predetermined one vehicle speed mode is, of the plurality of vehicle speed modes, one of which is selectable by the user, a vehicle speed mode different from a vehicle speed mode having a target speed of the vehicle (100) set to the highest value.

The accuracy of the information to be used to acquire the parking space information can be increased by setting the vehicle speed mode in the registration mode to the vehicle speed mode different from the vehicle speed mode having the target speed of the vehicle (100) set to the highest value. Thus, highly accurate parking space information can be acquired and registered.

The following configuration is applicable: the plurality of vehicle speed modes, one of which is selectable by the user are three vehicle speed modes including: a medium speed mode having the target speed of the vehicle (100) set to a predetermined value; a high speed mode having the target speed of the vehicle (100) set to a value higher than the predetermined value; and a low speed mode having the target speed of the vehicle (100) set to a value lower than the predetermined value, and the predetermined one vehicle speed mode is the low speed mode.

The following configuration is applicable: the predetermined one vehicle speed mode is, of the plurality of vehicle speed modes, one of which is selectable by the user, a vehicle speed mode having the lowest upper limit value of the travel speed of the vehicle (100).

The accuracy of the information acquired during the travel of the vehicle (100) increases as the vehicle speed decreases. Therefore, the accuracy of the information required to acquire the parking space information can be increased by setting the vehicle speed mode in the registration mode to the vehicle speed mode having the lowest upper limit value of the vehicle. Thus, highly accurate parking space information can be acquired and registered.

Further, the following configuration is applicable: the predetermined one vehicle speed mode is, of the plurality of vehicle speed modes, one of which is selectable by the user, a vehicle speed mode different from a vehicle speed mode having the highest upper limit value of the travel speed of the vehicle (100).

The accuracy of the information to be used to acquire the parking space information can be increased by setting the vehicle speed mode in the registration mode to the vehicle speed mode different from the vehicle speed mode having the highest upper limit value of the vehicle. Thus, highly accurate parking space information can be acquired and registered.

Further, the following configuration is applicable: the plurality of vehicle speed modes, one of which is selectable by the user are three vehicle speed modes including: a medium speed mode having an upper limit value of the travel speed of the vehicle (100) set to a predetermined value; a high speed mode having the upper limit value of the travel speed of the vehicle (100) set to a value higher than the predetermined value; and a low speed mode having the upper limit value of the travel speed of the vehicle (100) set to a value lower than the predetermined value, and the predetermined one vehicle speed mode is the low speed mode.

### BRIEF DESCRIPTION OF THE DRAWINGS

FIG. 1 is a diagram for illustrating a vehicle parking assist apparatus according to at least one embodiment of the present invention and a vehicle to which the vehicle parking assist apparatus is applied.

FIG. 2 is a view for illustrating an example of a setting menu image.

FIG. 3 is a flowchart for illustrating an example of processing of selecting a speed mode.

### DESCRIPTION OF THE EMBODIMENTS

Description is now given of at least one embodiment of the present invention with reference to the drawings. For the convenience of description, a vehicle parking assist apparatus 10 according to at least one embodiment of the present invention is sometimes abbreviated as “this apparatus 10” hereinafter. This apparatus 10 is configured to be able to execute parking assist control. The parking assist control is control of setting a target parking range in a parking space, and parking a vehicle 100 within the target parking range without requiring operations of an accelerator pedal 14, a brake pedal 15, and a steering wheel 16 by a driver. The target parking range is a range (region) in which the vehicle 100 is to be parked through the parking assist control, and has a size that can accommodate the vehicle 100. Moreover, this apparatus 10 parks the vehicle 100 through use of the parking assist control so that the vehicle 100 is accommodated within the target parking range. Further, this apparatus 10 is configured to be able to register information on the parking space having the target parking range set therein. Still further, this apparatus 10 is configured to control a vehicle speed in accordance with a vehicle speed mode during the execution of the parking assist control. Yet further, this apparatus 10 has a plurality of vehicle speed modes having vehicle speeds different from one another, and is configured to be able to set (select) one vehicle speed mode of the plurality of vehicle speed modes.

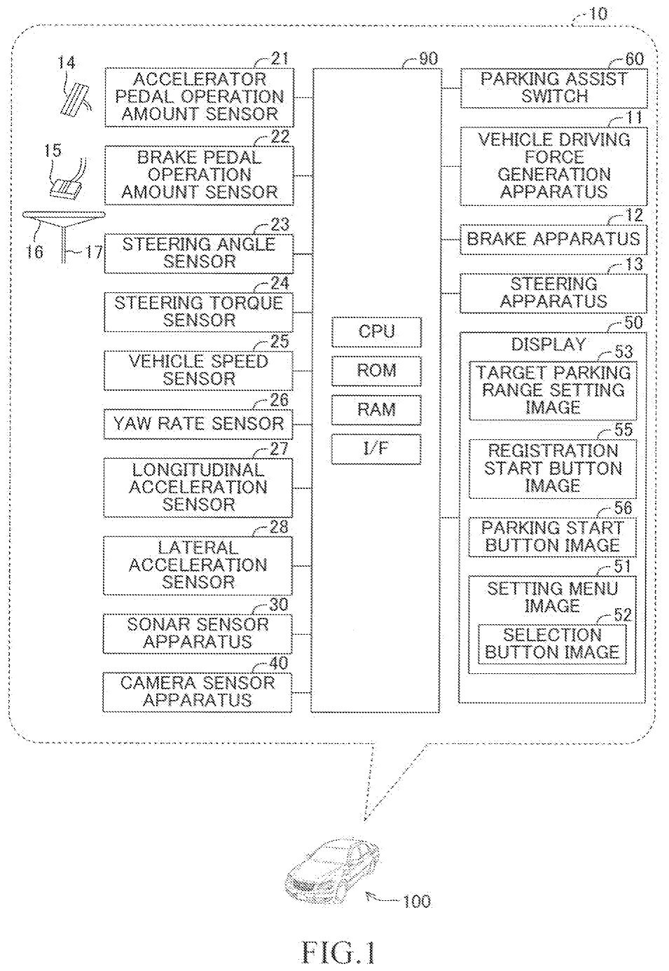

FIG. 1 is a diagram for illustrating this apparatus 10 and the vehicle 100 to which this apparatus 10 is applied. As illustrated in FIG. 1, this apparatus 10 includes an electronic control unit (ECU) 90. The ECU 90 includes a microcomputer. The microcomputer includes a CPU, a ROM, a RAM, a nonvolatile memory, and an interface (I/F). The CPU can read out an instruction, a program, or a routine stored in the ROM, to thereby load the instruction, the program, or the routine onto the RAM for execution. This apparatus 10 is configured to consequently implement various functions.

A parking assist switch 60 is mounted to the vehicle 100. The parking assist switch 60 is a switch operable by a driver or the like (a user of the vehicle 100). The parking assist switch 60 is electrically connected to the ECU 90, and the ECU 90 can thus detect the operation on the parking assist switch 60. Moreover, when the ECU 90 detects the operation on the parking assist switch 60, the ECU 90 starts the parking assist control.

A vehicle driving force generation apparatus 11, a brake apparatus 12, and a steering apparatus 13 are mounted to the vehicle 100. The vehicle driving force generation apparatus 11 is an apparatus configured to generate a driving force for causing the vehicle 100 to travel, to thereby apply the driving force to driving wheels of the vehicle 100. For example, an internal combustion engine, an electric motor, or the like is applied to the vehicle driving force generation apparatus 11. The brake apparatus 12 is an apparatus configured to apply a braking force for braking the vehicle 100 to wheels of the vehicle 100. The steering apparatus 13 is an apparatus configured to apply a steering torque for steering the vehicle 100 to steered wheels of the vehicle 100.

The vehicle driving force generation apparatus 11, the brake apparatus 12, and the steering apparatus 13 are electrically connected to the ECU 90. The ECU 90 is configured to control an operation of the vehicle driving force generation apparatus 11, to thereby control the driving force applied to the driving wheels of the vehicle 100. Moreover, the ECU 90 is configured to control an operation of the brake apparatus 12, to thereby control the braking force applied to the wheels of the vehicle 100. Further, the ECU 90 is configured to control an operation of the steering apparatus 13, to thereby control the steering torque applied to the steered wheels of the vehicle 100.

An accelerator pedal operation amount sensor 21, a brake pedal operation amount sensor 22, a steering angle sensor 23, a steering torque sensor 24, a vehicle speed sensor 25, a yaw rate sensor 26, a longitudinal acceleration sensor 27, a lateral acceleration sensor 28, a sonar sensor apparatus 30, and a camera sensor apparatus 40 are mounted to the vehicle 100 as sensors. Those sensors are electrically connected to the ECU 90.

The accelerator pedal operation amount sensor 21 is configured to be able to detect an operation amount of the accelerator pedal 14. The ECU 90 can acquire the operation amount of the accelerator pedal 14 detected by the accelerator pedal operation amount sensor 21. Moreover, the ECU 90 controls the operation of the vehicle driving force generation apparatus 11 so that the driving force is applied from the vehicle driving force generation apparatus 11 to the driving wheels of the vehicle 100 in accordance with the acquired operation amount of the accelerator pedal 14.

The brake pedal operation amount sensor 22 is configured to be able to detect an operation amount of the brake pedal 15 by the driver. The ECU 90 can acquire the operation amount of the brake pedal 15 detected by the brake pedal operation amount sensor 22. Moreover, the ECU 90 controls the operation of the brake apparatus 12 so that the braking force is applied from the brake apparatus 12 to the wheels of the vehicle 100 in accordance with the acquired operation amount of the brake pedal 15.

The steering angle sensor 23 is configured to be able to detect a rotational angle of the steering wheel 16 rotated from a neutral position. The ECU 90 can acquire the rotational angle detected by the steering angle sensor 23 as the steering angle. The steering torque sensor 24 is configured to be able to detect a torque input by the driver to the steering shaft 17. The ECU 90 can acquire the torque detected by the steering torque sensor 24 as the steering torque. Moreover, the ECU 90 controls the operation of the steering apparatus 13 so that a steering torque in accordance with the steering angle acquired from the steering angle sensor 23 and the steering torque acquired from the steering torque sensor 24 is applied to the steered wheels of the vehicle 100.

The vehicle speed sensor 25 is configured to be able to detect a rotational speed of each wheel of the vehicle 100. The ECU 90 can acquire the rotational speed of each wheel acquired by the vehicle speed sensor 25, to thereby be able to acquire the vehicle speed based on the acquired rotational speed of each wheel.

The yaw rate sensor 26 is configured to detect a yaw rate of the vehicle 100. The ECU 90 can acquire the yaw rate of the vehicle 100 detected by the yaw rate sensor 26.

The longitudinal acceleration sensor 27 is configured to be able to detect the longitudinal acceleration of the vehicle 100. The lateral acceleration sensor 28 is configured to be able to detect the lateral acceleration of the vehicle 100. The ECU 90 can acquire the longitudinal acceleration of the vehicle 100 detected by the longitudinal acceleration sensor 27 and the lateral acceleration of the vehicle 100 detected by the lateral acceleration sensor 28.

The sonar sensor apparatus 30 includes a predetermined number of clearance sonars. Each clearance sonar is mounted to the vehicle 100, and is configured to be able to emit a sound wave toward a predetermined direction outside the vehicle 100, and to receive the sound wave reflected by an object. Moreover, the sonar sensor apparatus 30 transmits information on the “sound wave emitted by each clearance sonar,” the “sound wave received by each clearance sonar,” and the like to the ECU 90. The ECU 90 can acquire information on objects existing around the vehicle 100 as the object information based on the information received from the sonar sensor apparatus 30.

The camera sensor apparatus 40 includes a plurality of cameras each configured to be able to take an image of a view around the vehicle 100. The plurality of cameras of the camera sensor apparatus 40 include a front camera configured to be able to take an image of a front view of the vehicle 100, a rear camera configured to be able to take an image of a rear view of the vehicle 100, a left-side camera configured to be able to take an image of a left view of the vehicle 100, and a right-side camera configured to be able to take an image of a right view of the vehicle 100. For the convenience of description, the image taken by the camera is sometimes referred to as “camera image.” The ECU 90 can acquire the camera image (that is, the image information on the view around the vehicle 100) of each camera through the camera sensor apparatus 40.

In addition, the vehicle 100 includes a display 50. The display 50 is arranged at a location visible by the driver. The display 50 in this example is a display 50 of a so-called navigation apparatus. A touch panel display configured to be able to display an image and to receive a touch operation is applied to the display 50. The display 50 is electrically connected to the ECU 90. Therefore, the ECU 90 can display various images on the display 50, and can detect the touch operation on the display 50.

The images to be displayed by the ECU 90 on the display 50 include a target parking range setting image 53, a registration start button image 55, a parking start button image 56, and a setting menu image 51.

The target parking range setting image 53 is an image to be used by the driver or the like to set and fix a position and a direction of the target parking range of the vehicle 100. Specific details of the target parking range setting image 53 are not particularly limited. The target parking range setting image 53 is only required to be configured so that the driver or the like can execute an operation of setting the position of the target parking range and an operation of fixing the position of the target parking range.

The registration start button image 55 is a button image on which a touch operation by the driver or the like is executed so as to register parking space information on the parking space having the target parking range set therein. When the ECU 90 detects the touch operation on the registration start button image 55, the ECU 90 determines that the registration mode is selected by the user. When the ECU 90 has not detected the touch on the registration start button image 55, the ECU 90 determines that the registration mode is not selected (determines that the registration mode is unselected).

After that, when the registration mode is selected, this apparatus 10 registers the parking space information on the parking space having the set target parking range in this apparatus 10. To “register the parking space information” is to store the parking space information in a recording medium, for example, the nonvolatile memory of the ECU 90, in a computer-readable manner.

As the parking space information to be registered, information on characteristics of a plurality of characteristic points existing in the parking space including the target parking range, at an entrance of the parking space, and in a periphery of the parking space and the entrance and information on coordinates of the plurality of characteristic points are applicable. Moreover, as the characteristic point, a local region, which is included in the parking space and the periphery of the parking space appearing in the camera images and is recognizable (distinguishable from the other portions), is applicable. Further, as the information on the characteristic of the characteristic point, brightness information (grayscale information) on the image at the characteristic point is applicable. The parking space information is not limited to the coordinates of the plurality of characteristic points and the brightness information on the image at the plurality of characteristic points. The parking space information is only required to be information allowing the vehicle parking assist apparatus 10 to recognize existence of the parking space and to acquire a relative positional relationship of the parking space to the vehicle 100 when the vehicle 100 approaches the parking space.

The parking start button image 56 is a button image on which a touch operation is executed by the driver in order to start parking travel processing described later. When this apparatus 10 detects the touch operation on the parking start button image 56, this apparatus 10 starts the parking travel processing of causing the vehicle 100 to travel to the target parking range.

The setting menu image 51 is an image to be used by the driver or the like to set items relating to the parking assist control. Description is later given of the setting menu image 51.

Description is now given of the parking assist control. The parking assist control is the control of setting the target parking range in the parking space, and parking the vehicle 100 within the target parking range without requiring the operations of the accelerator pedal 14, the brake pedal 15, and the steering wheel 16 by the driver. When the ECU 90 of this apparatus 10 detects the operation on the parking assist switch 60, the ECU 90 executes, as processing included in the parking assist control, processing (hereinafter sometimes referred to as “target setting processing”) of setting (fixing) a target parking range, and setting a target travel route, which is a route along which the vehicle 100 is caused to travel to the set target parking range. After that, when the ECU 90 of this apparatus 10 detects the touch operation on the parking start button image 56, the ECU 90 executes processing (hereinafter sometimes referred to as “parking travel processing”) of causing the vehicle 100 to travel along the set target travel route to the target parking range as processing included in the parking assist control.

Details of the target setting processing are not particularly limited, and, for example, the following processing is applicable. When the ECU 90 detects the operation on the parking assist switch 60, the ECU 90 displays the target parking range setting image 53. The target parking range setting image 53 includes, for example, a plan view image, a parking range line image, a move button image, and a parking range fix button image. The plan view image is an image including a plan view image of the vehicle 100 (image of the vehicle 100 viewed from above) and an image of the periphery of the vehicle 100 (image of the view around the vehicle 100), and is generated by the ECU 90 through use of the camera images. The parking range line image is a line image indicating the target parking range, and is superimposed on the plan view image so as to indicate the position and the direction of the target parking range with respect to the parking space. The move button image and the parking range fix button image are button images operable by the driver or the like through the touch operation. When the ECU 90 detects the touch operation on the move button image, the ECU 90 moves the parking range line image over the plan view image displayed on the display 50 in accordance with the touch operation. After that, when the ECU 90 detects the touch operation on the parking range fix button image, the ECU 90 fixes a position of the parking range line image superimposed on the plan view image as a position of the target parking range. Then, when this apparatus 10 fixes the target parking range, this apparatus 10 sets the target travel route for causing the vehicle 100 to travel in order to park the vehicle 100 within the target parking range. An algorithm for setting the target travel route is not particularly limited, and a publicly-known related-art algorithm is applicable.

The parking travel processing is processing of controlling the operation of the vehicle driving force generation apparatus 11, the operation of the brake apparatus 12, and the operation of the steering apparatus 13 based on the vehicle information such as the number of rotation of the tire, the steering angle, the steering torque, the vehicle speed, the yaw rate, the longitudinal acceleration, and the lateral acceleration, the image information, and the object information so that the vehicle 100 travels along the set target travel route to the set (fixed) target parking range. During the execution of the parking travel processing, each time a predetermined period elapses, this apparatus 10 repeats processing of “calculating the current position of the vehicle 100 from the vehicle information, calculating the positional relationship between the calculated current position of the vehicle 100 and the target parking range, and controlling the operations of the vehicle driving force generation apparatus 11, the brake apparatus 12, and the steering apparatus 13 based on the calculated positional relationship” so that the vehicle 100 travels to the target parking range along the target travel route.

As described above, this apparatus 10 has the “registration mode” in which the parking space information on the parking space having the target parking range set therein is registered. The registration mode is selectable. When this apparatus 10 detects the touch operation on the registration start button image 55 displayed on the display 50, this apparatus 10 determines that the registration mode is selected. When this apparatus 10 does not detect the touch operation, this apparatus 10 determines that the registration mode is not selected (determines that the registration mode is unselected).

Further, this apparatus 10 is configured to control the vehicle speed during the execution of the parking assist control in accordance with the vehicle speed mode. This apparatus 10 has the plurality of vehicle speed modes having vehicle speeds different from one another, and is configured to be able to set (select) one vehicle speed mode of the plurality of vehicle speed modes. Description is now given of an example in which this apparatus 10 has three speed modes of “high speed mode,” “medium speed (standard) mode,” and “low speed mode” as the plurality of vehicle speed modes. The “medium speed (standard) mode” is a vehicle speed mode having the target speed of the vehicle set to a predetermined vehicle speed. The “high speed mode” is a vehicle speed mode having the target speed of the vehicle set to a vehicle speed higher than that in the “medium speed (standard) mode” for the same target parking range or for the same target travel route. The “low speed mode” is a vehicle speed mode having the target speed of the vehicle set to a vehicle speed lower than that in the “medium speed (standard) mode” for the same target parking range or for the same target travel route. The specific target speed in each vehicle speed mode is not limited, and can appropriately be set. Alternatively, the “medium speed (standard) mode” is a vehicle speed mode having an upper limit value of the vehicle speed set to a predetermined value. The “high speed mode” is a vehicle speed mode having the upper limit value of the vehicle speed set to a value higher than the predetermined value. The “low speed mode” is a vehicle speed mode having the upper limit value of the vehicle speed set to a value lower than the predetermined value. Also in this case, the specific upper limit value of the vehicle speed in each vehicle speed mode is not limited, and can appropriately be set.

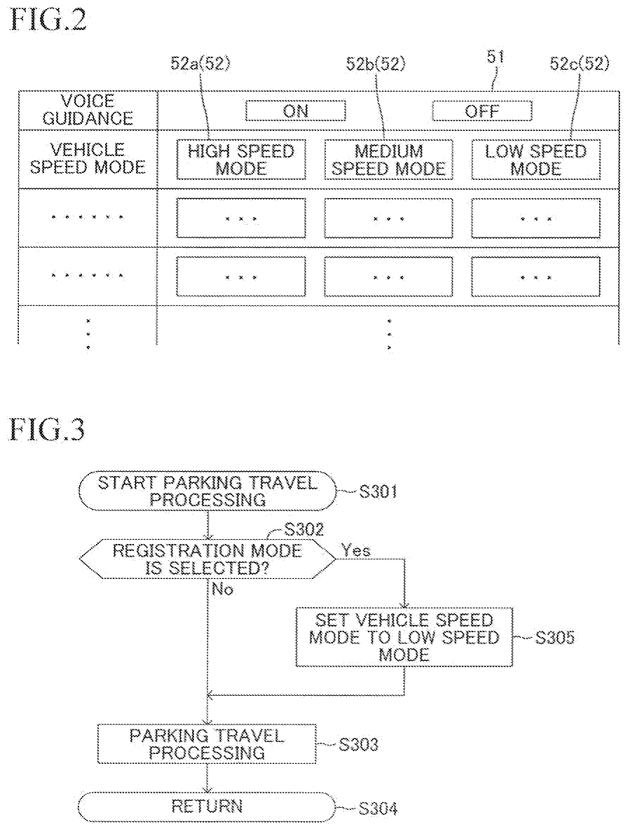

FIG. 2 is a view for illustrating an example of the setting menu image 51 for customizing the setting of the parking assist control. As illustrated in FIG. 2, the setting menu image 51 includes “vehicle speed mode” as one of items allowing the driver or the like to change settings and selection button images 52 for selecting the vehicle speed mode. Specifically, the selection button images 52 for selecting the vehicle speed mode include a selection button image 52a for selecting the “high speed mode,” a selection button image 52b for selecting the “medium speed (standard) mode,” and a selection button image 52c for selecting the “low speed mode”. When the ECU 90 detects the touch operation on any one of the selection button images 52 (52a, 52b, and 52c), the ECU 90 determines that the vehicle speed mode corresponding to the selection button image 52 (52a, 52b, or 52c) on which the touch operation is executed is selected. The selected vehicle speed mode is stored as a “currently set vehicle speed mode” in a recording medium, for example, the nonvolatile memory. A configuration of the setting menu image 51 is not limited to the example illustrated in FIG. 2. The setting menu image 51 is only required to be configured so that the driver or the like can select any one of the plurality of vehicle speed modes.

After that, when the registration mode is not selected, the ECU 90 controls the vehicle speed during the execution of the parking assist control in accordance with the selected vehicle speed mode (currently set vehicle speed mode). When the operation of selecting the vehicle speed mode has not been executed by the driver or the like, the ECU 90 controls the vehicle speed in accordance with a vehicle speed mode set as an initial value. In this apparatus 10, it is assumed that the “medium speed (standard) mode” is selected as the initial value. Meanwhile, when the registration mode is selected, the ECU 90 changes the vehicle speed mode to the predetermined one vehicle speed mode, and controls the vehicle speed in accordance with the changed vehicle speed mode. That is, when the registration mode is selected, the ECU 90 controls the vehicle speed in accordance with the predetermined one vehicle speed mode regardless of the vehicle speed mode selected (set) by the driver or the like (or the vehicle speed mode set as the initial value). In at least one embodiment, description is given of an example in which the “low speed mode” is applied to the predetermined one vehicle speed mode. The “low speed mode” is the vehicle speed mode which is different from the “high speed mode”.

Description is now given of an example of processing of changing the vehicle speed mode in accordance with whether or not the registration mode is selected. FIG. 3 is a flowchart for illustrating the example of the processing of changing the vehicle speed mode. This processing is processing included in the parking assist control, and a computer program for executing this processing is stored in advance in the ROM or the like of the ECU 90. Then, the CPU of the ECU 90 reads out this computer program from the ROM, and loads the computer program onto the RAM for execution. As a result, the processing illustrated in FIG. 3 is achieved.

When the ECU 90 detects the operation on the parking assist switch 60, and further detects the touch operation on the parking start button image 56, the ECU 90 starts this processing (Step S301). Then, in Step S302, the ECU 90 determines whether or not the registration mode is selected. When the registration mode is not selected (registration mode is unselected), the ECU 90 proceeds to Step S303. Meanwhile, when the registration mode is selected in Step S302, the ECU 90 proceeds to Step S305. In Step S305, the ECU 90 changes the vehicle speed mode to the “low speed mode” regardless of the currently set vehicle speed mode. When the currently set vehicle speed mode is the “low speed mode,” the ECU 90 does not change the vehicle speed mode to another speed mode, and maintains the currently set speed mode. Then, the processing proceeds to Step S303.

In Step S303, the ECU 90 executes the parking travel processing. In the parking travel processing, the ECU 90 controls the vehicle speed in accordance with the set vehicle speed mode. Therefore, when the ECU 90 determines that the registration mode is not selected in Step S302, the ECU 90 controls the vehicle speed in accordance with the vehicle speed mode selected by the driver or the like (or the vehicle speed mode set as the initial value). Meanwhile, when the ECU 90 determines that the registration mode is selected in Step S302, the ECU 90 controls the vehicle speed in accordance with the vehicle speed mode (that is, the low speed mode) changed in Step S305. Then, the processing proceeds to Step S304, and this processing is temporarily brought to an end.

The ECU 90 repeats such processing each time a predetermined period elapses.

As described above, when the registration mode is not selected, the vehicle speed in the parking travel processing is controlled in accordance with the vehicle speed mode set by the driver or the like. Meanwhile, when the registration mode is selected, the vehicle speed is controlled in accordance with the predetermined vehicle speed mode (that is, the low speed mode) regardless of the vehicle speed mode registered by the driver or the like.

In at least one embodiment, description has been given of the configuration in which this apparatus 10 has the three vehicle speed modes, and the driver or the like can select any one vehicle speed mode from those three vehicle speed modes, but the configuration is not limited to this example. For example, this apparatus 10 may be configured to have two vehicle speed modes, or may be configured to have four or more vehicle speed modes. In short, the vehicle parking assist apparatus 10 is only required to be configured to have a plurality of vehicle speed modes defining vehicle speeds different from one another.

Further, it is not required that the vehicle parking assist apparatus 10 be configured so that all of the plurality of vehicle speed modes are selectable by the driver or the like. For example, the vehicle parking assist apparatus may have three vehicle speed modes, and may be configured to allow the driver or the like to select the vehicle speed mode from two of the three vehicle speed modes. Moreover, in this configuration, the vehicle parking assist apparatus may be configured so that the vehicle speed is controlled in accordance with the remaining one vehicle speed mode not selectable by the driver or the like when the registration mode is selected. As described above, the vehicle parking assist apparatus is only required to be configured so that the plurality of vehicle speed modes include two or more vehicle speed modes, one of which is selectable by the user. Moreover, the vehicle parking assist apparatus is only required to be configured to control the vehicle speed in accordance with the predetermined one vehicle speed mode regardless of the vehicle speed mode selected by the driver or the like when the registration mode is selected.

With this configuration, accuracy of the parking space information to be acquired can be increased. That is, in the configuration in which the parking space information is acquired from the camera images, as the vehicle speed becomes higher, blur of the camera image (flows of the images caused by the movement of the vehicle 100) becomes larger. As a result, there is a fear in that a characteristic point may not be extracted, or a separation may occur between an actual characteristic of a characteristic point and an extracted characteristic of the characteristic point. Moreover, when the view around the vehicle 100 is taken by a plurality of cameras, a method of sequentially taking the images at a predetermined cycle is sometimes used. In this case, timings of taking the images by the respective cameras are shifted from one another, and a relative positional relationship of a characteristic point among different camera images becomes different from an actual positional relationship. Moreover, this difference becomes larger as the vehicle speed becomes higher. As a result, consistency among the plurality of camera images may not be maintained, and the accuracy of the acquired parking space information may thus decrease.

Moreover, the position of the vehicle 100 (the current position of the vehicle 100) during the execution of the parking travel processing is calculated from vehicle information (a distance traveled through the rotation of the tire, a steering angle of the steered wheels, the vehicle speed, and the like) acquired at a predetermined sampling cycle. Therefore, for example, when the steering angle is large during a transition from a straight travel to a turn, the actual vehicle information and the acquired vehicle information may be separated from each other depending on the sampling cycle. Further, when the vehicle speed is high, the vehicle 100 is liable to slip, and hence accuracy of the calculation of the current position of the vehicle 100 may decrease when the method of calculating the current position of the vehicle 100 from the above-mentioned vehicle information is used. Thus, there is a fear in that a difference may occur between a position (coordinates) of an extracted characteristic point and an actual position of the characteristic point, and as a result, the accuracy of the parking space information to be acquired may decrease.

Therefore, the ECU 90 of this apparatus 10 sets the vehicle speed mode to the predetermined one vehicle speed mode regardless of the vehicle speed mode selected by the driver or the like in the registration mode for registering the parking space information. Then, the ECU 90 controls the vehicle speed in accordance with this predetermined one vehicle speed mode. As the “predetermined one vehicle speed mode”, the “low speed mode” is applicable. The “low speed mode” is the vehicle speed mode which is different from the “high speed mode”. With this configuration, regardless of the vehicle speed mode selected by the driver or the like, the vehicle 100 can be caused to travel so that the actual vehicle speed is the vehicle speed appropriate for the acquisition of the information (for example, the camera images and the above-mentioned vehicle information) to be used to acquire the parking space information. Thus, the accuracy of the parking space information to be acquired (the parking space information to be registered) can be increased.

Moreover, the accuracy of the information (the camera images and the current position of the vehicle 100) acquired in order to acquire the parking space information increases as the vehicle speed decreases. Thus, other things being equal, the accuracy of the information acquired in order to acquire the parking space information can be increased by setting the vehicle speed mode to a vehicle speed mode having the lowest target speed or a vehicle speed mode having the lowest upper limit value of the vehicle speed of the vehicle speed modes, one of which is selectable by the driver or the like. As a result, the accuracy of the parking space information to be acquired can be increased.

Meanwhile, when the vehicle speed is low during the execution of the parking assist control, a period required to park the vehicle 100 within the target parking range is long. Therefore, in terms of the period required for the parking, it is preferred that the vehicle speed be high. Thus, as long as accuracy of the camera images, the vehicle information, and the like acquired in order to acquire the parking space information satisfies required accuracy, it is not required that the vehicle speed mode be the vehicle speed mode having the lowest vehicle speed. However, in the vehicle speed mode having the highest vehicle speed, the set vehicle speed (specifically, the set target speed or the set upper limit value of the vehicle speed) allows quick parking. Therefore, when the registration mode is selected, the vehicle speed mode may beset to a vehicle speed mode different from the vehicle speed mode having the highest vehicle speed. With this configuration, it is possible to reduce the period required for the parking within the target parking range while securing the accuracy of the camera images, the vehicle information, and the like to be acquired in order to acquire the parking space information.

<Example of Parking Assist Control>

Description is now given of an example of the parking assist control.

(Determination of Existence of Parking Space Having Registered Parking Space Information)

When the vehicle speed becomes equal to or lower than a predetermined value, the ECU 90 starts processing of acquiring characteristic points existing on a left side and a right side of the vehicle 100 from the camera images taken by the left-side camera and the right-side camera as new characteristic points, respectively, and acquiring grayscale information on the acquired new characteristic points. In this example, the characteristic point is an image in a predetermined region included in the camera image, and an image within a predetermined range in which brightness greatly changes.

When the vehicle 100 is stopped, the ECU 90 compares (or matches) the grayscale information on the acquired new characteristic points to grayscale information on registered entrance characteristic points. The entrance characteristic point is a characteristic point existing at the entrance of the parking space (extracted at the entrance of the parking space). The ECU 90 determines whether or not there exists the grayscale information on the acquired new characteristic points matching or substantially matching the grayscale information on the registered entrance characteristic points. Then, when matching or substantially matching characteristic points exist, the ECU 90 determines that a parking space having the registered parking space information (hereinafter sometimes referred to as “registered parking space”) exists on the side of the vehicle 100. Meanwhile, when matching or substantially matching characteristic points do not exist, the ECU 90 determines that a parking space not having the registered parking space information (hereinafter sometimes referred to as “unregistered parking space”) exists (a registered parking space does not exist).

(Processing of Parking Vehicle in Unregistered Parking Space in Registration Mode)

Description is now given of processing to be executed when the ECU 90 determines that an unregistered parking space exists. When the ECU 90 detects the operation on the parking assist switch 60, the ECU 90 displays the target parking range setting image 53 on the display 50. In this case, the ECU 90 includes a view of the unregistered parking space in the target parking range setting image 53. After that, when the ECU 90 detects the touch operation on the move button image, the ECU 90 moves the parking range line image in accordance with the touch operation. Then, when the ECU 90 detects the touch operation on the parking range fix button image, the ECU 90 sets (fixes) a position of the parking range line image as the target parking range, and simultaneously sets a target travel route so that the vehicle 100 is parked within the set target parking range. Moreover, the ECU 90 displays the registration start button image 55 and the parking start button image 56 on the display 50.

When the ECU 90 detects the touch operation on the registration start button image 55, the ECU 90 determines that the registration mode is selected. That is, the ECU 90 starts the processing of registering the parking space information on the parking space having the set target parking range. Moreover, when the registration mode is selected (when the ECU 90 detects the touch operation on the registration start button image 55), the ECU 90 sets the vehicle speed mode to the “low speed mode” regardless of the vehicle speed mode set by the driver or the like.

Further, when the ECU 90 detects the touch operation on the parking range fix button image, the ECU 90 acquires a predetermined number of one or more new characteristic points as the entrance characteristic points of this unregistered parking space. Moreover, when the ECU 90 acquires the entrance characteristic points, the ECU 90 stores in the RAM coordinates of each of the acquired entrance characteristic points in a temporary coordinate system as temporary entrance coordinates, and stores in the RAM grayscale information on each of the acquired entrance characteristic points as temporary entrance grayscale information. The temporary coordinate system is a coordinate system having a predetermined position within the target parking range as the origin.

Then, when the ECU 90 detects the touch operation on the parking start button image 56, the ECU 90 executes the parking travel processing of causing the vehicle 100 to travel to the target parking range along the set target travel route. During the execution of the parking travel processing, the ECU 90 controls the vehicle speed so that the vehicle speed is the vehicle speed in the “low speed mode” regardless of the vehicle speed mode set by the driver or the like. While the ECU 90 is executing the parking travel processing, and causing the vehicle 100 to travel backward, the ECU 90 acquires a plurality of characteristic points existing on the rear side of the vehicle 100 as intermediate characteristic points, stores coordinates of the acquired intermediate characteristic points in the temporary coordinate system as temporary intermediate coordinates in the RAM or the like, and stores grayscale information on the acquired intermediate characteristic points as temporary intermediate grayscale information in the RAM or the like.

When the entire vehicle 100 has been accommodated within the target parking range, the ECU 90 stops the vehicle 100, and ends the parking travel processing. As a result, the parking of the vehicle 100 in the unregistered parking space is completed. In this case, the ECU 90 acquires one or more characteristic points existing on the front side of the vehicle 100 (front characteristic points) and one or more respective characteristic points existing on the left side and the right side of the vehicle 100 (left characteristic points and right characteristic points) as new front side characteristic points, new left side characteristic points, and new right side characteristic points, respectively. After that, the ECU 90 acquires coordinates of those acquired new characteristic points in a registration coordinate system, and simultaneously acquires grayscale information on those acquired new characteristic points. The registration coordinate system is a coordinate system having a center position of a shaft connecting a left rear wheel and a right rear wheel of the vehicle 100 to each other in a widthwise direction of the vehicle 100 when the parking of the vehicle 100 within the target parking range is completed as the origin. Then, the ECU 90 registers the coordinates in the registration coordinate system and the grayscale information of the new characteristic points as the parking space information on the parking space including the target parking range.

Moreover, the ECU 90 converts the coordinates of the entrance characteristic points in the temporary coordinate system to coordinates in the registration coordinate system, and registers the coordinates in the registration coordinate system and the grayscale information of the entrance characteristic points as the parking space information on the parking space including the target parking range. In addition, the ECU 90 converts the coordinates of the intermediate characteristic points in the temporary coordinate system to coordinates in the registration coordinate system, and registers the coordinates in the registration coordinate system and the grayscale information of the intermediate characteristic points as the parking space information on the parking space including the target parking range.

As described above, this apparatus 10 registers the coordinates in the registration coordinate system and the grayscale information of the respective entrance characteristic points, intermediate characteristic points, rear characteristic points, front characteristic points, left characteristic points, and right characteristic points as the parking space information.

(Processing of Parking Vehicle in Unregistered Parking Space not in Registration Mode)

When the ECU 90 detects the touch operation on the parking start button image 56 without detecting the touch operation on the registration start button image 55, the ECU 90 determines that the registration mode is not selected (determines that the registration mode is unselected), and executes the parking travel processing. In this case, the same processing as the above-mentioned “Processing of Parking Vehicle 100 in Unregistered Parking Space in Registration Mode” is executed except for a point that characteristic points are not extracted during the backward travel of the vehicle 100 and after the arrival at the target parking range and a point that the parking space information is not registered. However, the ECU 90 controls the vehicle speed in accordance with the vehicle speed mode set by the driver or the like.

(Processing of Parking Vehicle in Registered Parking Space)

When the ECU 90 determines that a registered parking space exists in the vicinity of the vehicle 100, the ECU 90 displays the camera images, the plan view image, the parking range line image, and the parking start button image 56 on the display 50. In this case, the ECU 90 includes views of the registered parking space in the camera images and the plan view image.

Then, when the ECU 90 detects a touch operation on the parking start button image 56, the ECU 90 fixes a parking range at a position corresponding to the parking range line image displayed on the display 50 as a target parking range, and sets a target travel route for causing the vehicle 100 to travel so that the vehicle 100 is parked within the fixed target parking range. After that, this apparatus 10 executes the parking travel processing of causing the vehicle 100 to travel to the target parking range along the target travel route. During the parking travel processing, the ECU 90 controls the vehicle speed so that the vehicle speed is the vehicle speed in accordance with the vehicle speed mode set by the driver or the like.

Description has been given of at least one embodiment of the present invention, but the present invention is not limited to at least one embodiment described above. The present invention may adopt various modification examples without departing from the spirit of the present invention.

For example, in at least one embodiment described above, description is given of the configuration in which the vehicle parking assist apparatus 10 has the three vehicle speed modes of “high speed mode,” “medium speed (standard) mode,” and “low speed mode,” and sets the vehicle speed mode to “low speed mode” when the registration mode is selected, but the configuration is not limited to this example. The vehicle parking assist apparatus 10 may be configured to have two vehicle speed modes, or may be configured to have four or more vehicle speed modes.

Moreover, in at least one embodiment described above, description has been given of the configuration in which when the registration mode is selected, the vehicle speed mode is set to the “low speed mode,” namely, the vehicle speed mode having the lowest vehicle speed (specifically, the lowest target speed or the lowest upper limit value of the vehicle speed), but the configuration is not limited to this example. As long as information satisfying the required accuracy can be acquired, it is not required that the vehicle speed mode be the vehicle speed mode having the lowest vehicle speed (specifically, the lowest target speed or the lowest upper limit value of the vehicle speed). Moreover, the specific target speed or the specific upper limit value of the vehicle speed in each vehicle speed mode is not limited, and can appropriately be set.

Moreover, in at least one embodiment described above, description has been given of the configuration in which the driver or the like (the user of the vehicle 100) can select any one vehicle speed mode of the plurality of vehicle speed modes of the vehicle parking assist apparatus 10, but the configuration is not limited to this example. For example, the plurality of vehicle speed modes of the vehicle parking assist apparatus 10 may include a vehicle speed mode not selectable by the driver or the like. Moreover, in this configuration, when the registration mode is selected, the vehicle speed may be controlled in accordance with the vehicle speed mode not selectable by the driver or the like. The point is, when the registration mode is selected, the vehicle speed is only required to be a vehicle speed at which the accuracy of the information acquired in order to acquire the parking space information is secured.

What is claimed is:

1. A vehicle parking assist apparatus, which is configured to execute parking travel processing of causing a vehicle to travel so that the vehicle is accommodated within a target parking range set in a parking space, the vehicle parking assist apparatus having:
a registration mode selectable by a user to register information on the parking space having the target parking range set therein; and
a plurality of vehicle speed modes having different travel speeds of the vehicle during the execution of the parking travel processing,
wherein the plurality of vehicle speed modes include two or more vehicle speed modes, one of which is selectable by the user,
wherein when the registration mode is not selected, during the execution of the parking travel processing, the vehicle parking assist apparatus controls a vehicle speed in accordance with one of the plurality of vehicle speed modes selected by the user, and
wherein when the registration mode is selected, during the execution of the parking travel processing, the vehicle parking assist apparatus controls a vehicle speed in accordance with a predetermined one vehicle speed mode of the plurality of vehicle speed modes regardless of one of the plurality of vehicle speed modes selected by the user.

2. The vehicle parking assist apparatus according to claim 1, wherein the predetermined one vehicle speed mode is, of the plurality of vehicle speed modes, one of which is selectable by the user, a vehicle speed mode having a target speed of the vehicle set to the lowest value.

3. The vehicle parking assist apparatus according to claim 2, wherein the predetermined one vehicle speed mode is, of the plurality of vehicle speed modes, one of which is selectable by the user, a vehicle speed mode different from a vehicle speed mode having a target speed of the vehicle set to the highest value.

4. The vehicle parking assist apparatus according to claim 1,
wherein the plurality of vehicle speed modes, one of which is selectable by the user are three vehicle speed modes including:
a medium speed mode having the target speed of the vehicle set to a predetermined value;
a high speed mode having the target speed of the vehicle set to a value higher than the predetermined value; and
a low speed mode having the target speed of the vehicle set to a value lower than the predetermined value, and
wherein the predetermined one vehicle speed mode is the low speed mode.

5. The vehicle parking assist apparatus according to claim 1, wherein the predetermined one vehicle speed mode is, of the plurality of vehicle speed modes, one of which is selectable by the user, a vehicle speed mode having the lowest upper limit value of the travel speed of the vehicle.

6. The vehicle parking assist apparatus according to claim 5, wherein the predetermined one vehicle speed mode is, of the plurality of vehicle speed modes, one of which is selectable by the user, a vehicle speed mode different from a vehicle speed mode having the highest upper limit value of the travel speed of the vehicle.

7. The vehicle parking assist apparatus according to claim 1,
wherein the plurality of vehicle speed modes, one of which is selectable by the user are three vehicle speed modes including:
a medium speed mode having an upper limit value of the travel speed of the vehicle set to a predetermined value;
a high speed mode having the upper limit value of the travel speed of the vehicle set to a value higher than the predetermined value; and
a low speed mode having the upper limit value of the travel speed of the vehicle set to a value lower than the predetermined value, and
wherein the predetermined one vehicle speed mode is the low speed mode.
